(19) United States
(12) Patent Application Publication
(10) Pub. No.: US 2016/0219456 A1
(43) Pub. Date: Jul. 28, 2016

(54) MOBILITY CONTROL DEVICE, MOBILE COMMUNICATION DEVICE, AND METHOD FOR PROVIDING MOBILITY SERVICE IN MULTI-MOBILE NETWORK ENVIRONMENT

(71) Applicant: ELECTRONICS AND TELECOMMUNICATIONS RESEARCH INSTITUTE, Daejeon (KR)

(72) Inventors: Jae Chan SHIM, Daejeon (KR); Pyung Koo PARK, Daejeon (KR); Ho Yong RYU, Daejeon (KR)

(21) Appl. No.: 14/997,556

(22) Filed: Jan. 17, 2016

(30) Foreign Application Priority Data
Jan. 27, 2015 (KR) 10-2015-0012948

(51) Int. Cl. H04W 28/02; H04W 4/02; H04W 24/10; H04W 24/08

(52) U.S. Cl. CPC H04W 28/0268; H04W 24/08; H04W 4/02; H04W 24/10; H04W 88/06

(57) ABSTRACT

A mobility control device, a mobile communication device, and mobility providing method providing a mobility service based on a tunnel in an environment with multiple mobile networks. A method for providing a mobility service in an environment with multiple mobile networks includes; receiving, by a mobility control device, positional information from a mobile communication device; acquiring, by the mobility control device, communication quality information in an area corresponding to the positional information for each of the multiple mobile networks, and transmitting, by the mobility control device, the communication quality information to the mobile communication device.

### CROSS-REFERENCE TO RELATED APPLICATIONS

This application claims priority to and the benefit of Korean Patent Application No 10-2015-0012948 filed in the Korean Intellectual Property Office on Jan. 27, 2015, the entire contents of which are incorporated herein by reference.

### BACKGROUND OF THE INVENTION

1. Field of the Invention

The present invention relates to a mobility control device and a mobile communication device providing a mobility service based on a tunnel in an environment with multiple mobile networks.

2. Description of Related Art

In recent years, various mobile network services including wireless fidelity (WiFi), 2 generation (2G), 3G, worldwide interoperability for microwave access (WiMax), long term evolution (LTE), and the like have been provided. A mobile communication device may have multiple interfaces corresponding to various access networks in order to receive various mobile network services.

The mobile communication device including the multiple interfaces may receive a mobility service based on a tunnel. That is, when the mobile communication device moves in an interned network or moves to an external network, an active tunnel and a stand-by tunnel may be configured and mobility may be provided to a terminal through the tunnels.

Multiple tunnels (the active tunnel and the stand-by tunnel) are configured in the interfaces of the mobile communication device in order to provide the mobility, but since data is transmitted through only an active interface, the mobile communication device accessed by multiple user terminals, such as a mobile router may be low in overall network usage efficiency.

### BRIEF SUMMARY OF THE INVENTION

The present invention has been made in an effort to provide a method that distributes traffic according to a load balancing mode, a load balancing policy, and an operating status of an interface module and reflects communication quality information based on positional information of a mobile communication device to achieve high data transmission efficiency, and a mobile control device and a mobile communication device that can perform the method, in an environment with multiple mobile networks in which the mobility service is provided.

Other technical problems and solving means of the present invention can be appreciated by the following description and will be more apparent by the exemplary embodiments of the present invention. Further, the technical problem and the solving means of the present invention can be implemented by means and combinations thereof described in claims.

An exemplary embodiment of the present invention provides a mobility control device providing a mobility service in an environment with multiple mobile networks, including: a network quality managing module monitoring and storing communication quality information depending on an area for each of the multiple mobile networks, a control module acquiring communication quality information in an area corresponding to positional information received from a mobile communication device for each of the multiple mobile networks; and a communication module transmitting the communication quality information to the mobile communication device.

In this case, the communication quality information may be acquired as relative values of the quality factors for the multiple mobile networks in the area.

The positional information may be received from the mobile communication device at a predetermined cycle or whenever the position of the mobile communication device is changed and the communication module may transmit the communication quality information at a predetermined cycle or whenever the position of the mobile communication device is changed.

The quality factors may include at least one of received signal strength (RSS) values, round trip time (RTT) values, and relative bandwidth (RB) values for the multiple mobile networks, and a moving direction (MD) value and a moving speed (MS) value of the mobile communication device in the area.

The control module may generate a static mode setting signal which is a signal that sets the mobile communication device to distribute traffic at a predetermined load balancing ratio, and the communication module may transmit the static mode setting signal to the mobile communication device.

The control module may generate load balancing policy information indicating an interface module which the mobile communication device uses in distributing the traffic, and the communication module may transmit the load balancing policy information to the mobile communication device.

Another exemplary embodiment of the present invention provides a mobile communication device in an environment with multiple mobile networks, including: multiple interface modules for accessing the multiple mobile networks; an interface quality measuring module acquiring quality factors for the multiple mobile networks from the multiple interface modules; and an interface control module calculating a load balancing ratio based on communication quality information for the multiple respective mobile networks, which is received from the outside and the quality factors and distributing traffic to the multiple interface modules according to the load balancing ratio.

The mobile communication device may further include a positional information acquiring module acquiring positional information of the mobile communication device and at least one of the multiple interface modules may transmit the positional information to the mobility control device.

In this case, the communication quality information may include communication quality information for the multiple respective mobile networks in an area corresponding to the positional information of the mobile communication device. Further, the communication quality information may be acquired based on the quality factors for the multiple mobile networks in the area corresponding to the positional information.

The quality factors may include at least one of received signal strength (RSS) values, round trip time (RTT) values, and relative bandwidth (RB) values for the multiple mobile networks, and a moving direction (MD) value and a moving speed (MS) value of the mobile communication device.

The interface control module may distribute the traffic at a predetermined load balancing ratio when acquiring a static mode setting signal.

The interface control module may calculate the load balancing ratio based on an interface module indicated by load balancing policy information when acquiring the load balancing policy information.

When a preliminary interface module is included in the multiple interface modules, the interface control module may exclude the preliminary interface module in calculating the load balancing ratio.

When failure is sensed in at least one of the multiple interface modules, the interface control module may exclude at least one interface module of which the failure is sensed in calculating the load balancing ratio.

When the preliminary interface module is included in the multiple interface modules, the interface control module may consider the preliminary interface module in calculating the load balancing ratio.

The communication quality information may be received at a predetermined cycle, and the interface control module may calculate the load balancing ratio at the predetermined cycle.

The interface control module may calculate the load balancing ratio at a predetermined cycle or whenever the communication quality information is received.

According to exemplary embodiments of the present invention, since traffic is distributed based on communication quality information based on positional information of a mobile communication device and a quality factor measured by the mobile communication device, interference operating efficiency can be increased by reflecting an actual network situation.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 illustrates an environment in which a mobility supporting service is provided in multiple mobile networks according to various exemplary embodiments of the present invention.

FIG. 2 is a block diagram of a mobility control device according to an exemplary embodiment of the present invention.

FIG. 3 illustrates communication quality information (quality factor weight)according to an exemplary embodiment of the present invention.

FIG. 4 is a block diagram of a mobile communication device according to an exemplary embodiment of the present invention.

FIG. 5 illustrates a method in which a mobility control device provides a mobility service according to an exemplary embodiment of the present invention.

FIG. 6 illustrates a method in which a mobility communication device receives a mobility service according to an exemplary embodiment of the present invention.

FIG. 7 illustrates a method in which a mobility control device provides a mobility service according to another exemplary embodiment of the present invention.

FIG. 8 illustrates a method in which a mobility communication device receives a mobility service according to another exemplary embodiment of the present invention.

FIG. 9 illustrates a method for receiving the mobility service when failure occurs in the mobility communication device according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention may be variously modified and have several exemplary embodiments. Therefore, specific exemplary embodiments of the present invention will be illustrated in the accompanying drawings and be described in detail. However, this is not intended to limit the present invention to the specific exemplary embodiments, and it should be understood that the present invention covers all the modifications, equivalents and replacements included in the spirit and technical scope of the present invention. In describing the present invention, when it is determined that the detailed description of the publicly known art related to the present invention may obscure the gist of the present invention, the detailed description thereof will be omitted.

Terms used in the present application are used only to describe specific exemplary embodiments, and are not intended to limit the present invention. Singular expressions used herein include plurals expressions unless they have definitely opposite meanings in the context. In the present application, it should be understood that the term “include” or “have indicates that a feature, a number, a component, a part or the combination thereof described in the specification is present, but does not exclude a possibility of presence or addition of one or more other features, numbers, components, parts or combinations thereof, in advance.

Hereinafter, exemplary embodiments of the present invention will be described in detail with reference to the accompanying drawings.

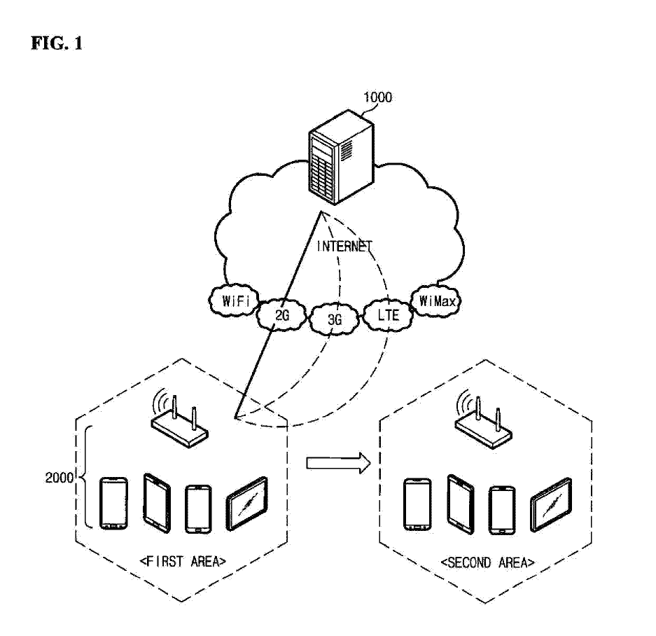

FIG. 1 illustrates an environment in which a mobility supporting service is provided in multiple mobile networks according to various exemplary embodiments of the present invention.

Referring to FIG. 1, an environment with multiple mobile networks may include a mobility control device 1000, a mobile communication device 2000, multiple mobile networks, and an Internet.

The mobility control device 1000 is connected to the Internet to manage and control mobility of the mobile communication device 2000 in a tunnel-based mobile network. The mobility control device 1000 may be provided as a part of a server connected to the Internet or mounted on the server in software (in this case, the server may be called a mobility integrated control server).

The mobility control device 1000 may perform access authentication for the network of the mobile communication device 2000 and tunnel setting. Further, the mobility control device 1000 may manage quality of an operating mobile network, a position of the mobile communication device 2000, a load distribution mode, a load distribution policy, and communication quality information for each area for each of the multiple mobile networks (for example, a quality factor weight for each area).

The mobile communication device 2000 may receive mobility based on the tunnel under the management of the mobility control device 1000. The mobile communication device 2000 may include an interface corresponding to various mobile networks. A user may be accessed to the Internet through various mobile networks by using the mobile communication device 2000.

In detail, the mobile communication device 2000 performs network access authentication through the mobile network, and when the authentication is completed, the mobile communication device 2000 may set an active tunnel with the mobility control device 1000 by receiving an IP address. Generally, as the active tunnel, a mobile network with the best quality (determined by the interface of the mobile communication device 2000) among the mobile networks may be set. Meanwhile, the mobile communication device 2000 may set another mobile network as a stand-by tunnel in order to receive mobility. For example, in FIG. 1, a 2G network is set as the active tunnel (bold line), and a 3G network and an LTE network are set as the stand-by tunnel (dotted line). When the mobile communication device 2000 moves from a first area to a second area, the active tunnel and the stand-by tunnel may be used.

Meanwhile, the mobile communication device 2000 may include, for example, a personal potable terminal such as a smart phone, a tablet PC, and a notebook PC, and a mobile router installed on a mobile means such as a bus, a train, and a car. There a personal potable terminal and the mobile router commonly have a plurality of interfaces. However, there is a difference in that the mobile router is accessed with the plurality of personal portable terminals, for example, through Wi-Fi to provide a communication service to the users of the plurality of personal portable terminals.

The mobile network may include various mobile networks such as wireless fidelity (Wi-Fi), 2 generation (2G), 3G, worldwide interoperability for microwave access (WiMax), and long term evolution (LTE). As described above, the mobile communication device 2000 including various interfaces may be accessed to the Internet through the mobile network.

In the environment of the multiple mobile networks, when the mobility support service is provided, the mobile communication device 2000 selects an interface of a mobile network with excellent quality among various interfaces to set the selected interface as the active tunnel or the stand-by tunnel. However, when the mobile communication device 2000 during moving measures quality of the mobile network through the interface and sets the tunnel by considering only the quality measured in the corresponding mobile communication device 2000, it is difficult to actually reflect an operation situation of each of the mobile networks.

For example, there may be a difference between the quality of the mobile network which is actually operating and the quality derived through the interface of the mobile communication device 2000. For example, it is assumed that in the first area, mobile networks A, B, and C are serviced, and actual network quality is best in A and next best in B and C in order (that is, A>B>C). In this case, the mobile communication device 2000 may allocate data to be transmitted to the interface of the mobile network A with the highest ratio, the data to the interface of the mobile network B with the second higher ratio, and allocates the remaining data to the interface of the mobile network C.

However, the actual quality of the mobile network measured in the interface of the mobile communication device 2000 may be determined in the order of the mobile network B>mobile network A>mobile network C. That is, when only the quality measured in the interface of the mobile communication device 2000 is considered, an operating situation of an actual network may not be accurately reflected, and furthermore, a data traffic operating situation of the actual mobile network according to a local area may not be considered. As a result, the data traffic is not efficiently distributed in the multiple mobile networks and overall network usage efficiency may deteriorate.

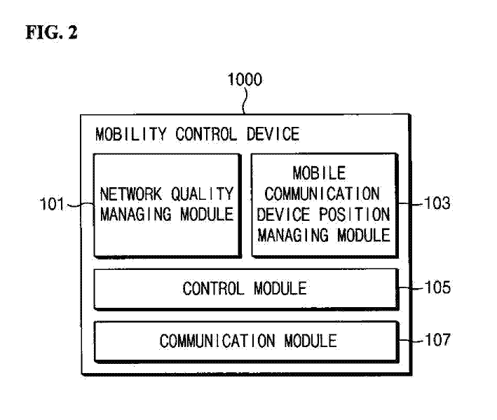

FIG. 2 is a block diagram of a mobility control device according to an exemplary embodiment of the present invention.

Referring to FIG. 2, the mobility control device 1000 providing a mobility service in the environment with the multiple mobile networks may include a network quality managing module 101, a mobile communication device position managing module 103, a control module 105, and a communication module 107.

The network quality managing module 101 may monitor and store communication quality information according to an area for each of the multiple mobile networks. That is, the network quality managing module 101 may monitor communication quality information for each mobile network which is serviced in each area covered by the corresponding mobility control device 1000 and may store, update, and manage the corresponding communication quality information. The managed communication quality information may be referred to by the control module 105.

The ‘communication quality information’ for each mobile network may be obtained based on a quality factor for the multiple mobile networks in each area. For example, the communication quality information may mean a relative value (that is, a quality factor weight) of the quality factors. In this specification, it is described that the ‘communication quality information’ is the ‘quality factor weight’, but is not limited thereto.

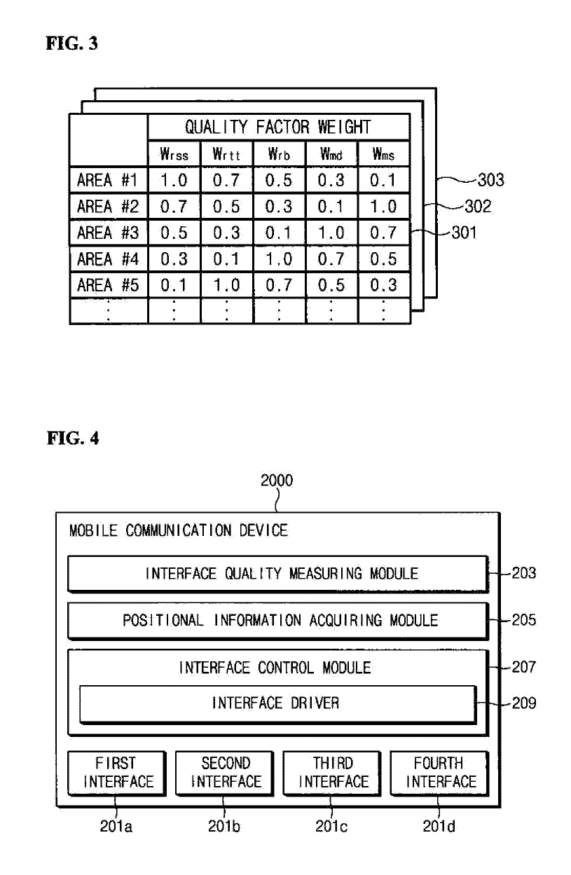

FIG. 3 illustrates communication quality information (a quality factor weight) according to an exemplary embodiment of the present invention.

Referring to FIG. 3, the communication quality information (the quality factor weight) according to an area is illustrated for every mobile network. For example, communication quality information 301 may be communication quality information of a 3G network according to each area, communication quality information 302 may be communication quality information of an LTE network according to each area, and communication quality information 303 may be communication quality information of a WiMax network according to each area

Each of the communication quality information 301, 302, and 303 represents a relative value (a quality factor weight) of the quality factor in each area covered by the corresponding mobility control device 1000. For example, as a relative value (a quality factor weight) of a quality factor in area #2, Wrss represents 0.7, Wrtt represents 0.5, Wrb represents 0.3, Wmd represents 0.1, and Wms represents 1.0.

In this case, the quality factor may be an index representing a network operating state for each area to correspond to a position change of the mobile communication device 200. The quality factor (alternatively, a quality parameter) may include at least one of the following values.

1. Received signal strength (RSS) information for each mobile network in the corresponding area. Since the RSS information varies according to a kind and a type of mobile network, the control module 105 may convert and use the RSS into a percentage.

2. Actual round trip time (RTT) information with the mobility control device for each mobile network in the corresponding area. The RTT is a value for the time, and the RTF value may be applied to each mobile network as a relative value calculated based on the fastest mobile network.

3. Bandwidth information of the mobile network in the corresponding area. The control module 105 may calculate a relative bandwidth (RB) value of each mobile network based on a bandwidth value of a mobile network with the maximum bandwidth.

4. Moving direction (MD) information of the mobile communication device 2000 which standardizes a geographical location of a base station corresponding to each mobile network in the corresponding area. The control module 105 may calculate the MD value of the mobile communication device 2000 for each mobile network based on the geographical location information of the base station and the MD information of the mobile communication device 2000. The MD value is a relative value considering a case where the mobile communication device 2000 is close to the base station and a case where the mobile communication device 2000 is far away from the base station.

5. Moving speed (MS) information of the mobile communication device. The MS information is a relative value for the MS of the mobile communication device 200.

Referring back to FIG. 2, the mobile communication device position managing module 103 receives a position of at least one mobile communication device 2000 and may store, update, and manage position information of the mobile communication device 2000. The mobile communication device position managing module 103 may receive and update position information in real time or for each predetermined period from at least one mobile communication device 2000. Meanwhile, the position information may be received whenever the position of at least one mobile communication device 2000 is changed. The received position information may be transferred to the control module 105.

The control module 105 may acquire communication quality information (a quality factor weight) in an area corresponding to the position information received from the mobile communication device 2000 for every multiple mobile networks. That is, the control module 105 may acquire the quality factor weight corresponding to the position information by applying the position information received from the mobile communication device position managing module 103 to the communication quality information stored in the network quality managing module.

For example, in FIG. 3, when the mobile communication device 2000 is positioned in area #2, the mobile communication device 2000 may transmit the position information to the mobility control device 1000, and the control module 105 of the mobility control device 1000 may acquire three pieces of communication quality information (quality factor weights). In any one quality factor weight 301 among the three pieces of communication quality information, Wrss may have a value of 0.7, Witt may have a value of 0.5, Wrb may have a value of 0.3, Wmd may have a value of 0.1, and Wms may have a value of 1.0.

Meanwhile, according to any exemplary embodiment, the mobility control device 1000 may manage a load distribution mode of the mobile communication device 2000. In this case, the control module 105 may generate a signal for controlling the load distribution mode (a load distribution mode setting signal) based on the position information received from the mobile communication device 2000 or according to an operation of the user.

The load distribution mode setting signal includes, for example, a dynamic mode setting signal and a static mode setting signal. The dynamic mode setting signal may be a signal setting to distribute traffic according to a load distribution ratio calculated based on the communication quality information according to the position information and the quality factor measured in the interface by the mobile communication device 2000. The static mode setting mode may be a signal setting to distribute traffic with a predetermined load distribution ratio by the mobile communication device 2000.

According to any other exemplary embodiment, the mobility control device 1000 may additionally manage a load distribution policy of the mobile communication device 2000. In this case, the control module 105 may generate information for controlling the load distribution policy (so called load distribution policy information) based on the position information received from the mobile communication device 2000 or according to an operation of the user.

The load distribution policy information may be information indicating a specific interface module used in distributing the traffic by the mobile communication device 2000. For example, when it is assumed that there are ten different interfaces, the load distribution policy information may include information in which the mobile communication device 2000 uses only specific eight interface modules in traffic distribution and the remaining two interface modules are not used in the distribution. That is, with respect to only the eight specific interface modules, the load distribution ratio may be calculated, and the traffic distribution may be performed according to the calculated load distribution ratio.

The communication module 107 may transmit at least one of the communication quality information, the load distribution mode setting signal, and the load distribution policy information to the mobile communication device. For example, the communication module 107 may transmit at least one of the communication quality information, the load distribution mode setting signal, and the load distribution policy information for every predetermined period. Alternatively, the communication module 107 may transmit at least one of the communication quality information, the load distribution mode setting signal, and the load distribution policy information whenever the changed position information of the mobile communication device 2000 is received.

The communication module 107 may be implemented as a configuration capable of transceiving predetermined information by communicating with the mobile communication device 2000 through the Internet. For example, various interfaces described above may be provided and different wired interfaces may be provided.

FIG. 4 is a block diagram of a mobile communication device 2000 according to an exemplary embodiment of the present invention.

Referring to FIG. 4, the mobile communication device 2000 in an environment with multiple mobile networks may include first to fourth interface modules 201a to 201d, an interface quality measuring module 203, a positional information acquiring module 205, and interface control module 207. Although not illustrated, the mobile communication device 2000 may extensively include, for example, various sensor modules, input devices, displays, display drivers, power managing modules, and the like.

The first to fourth interface modules 201a to 201d may access mobile networks corresponding thereto, respectively. For example, the first to fourth interface modules 201a to 201d may access a 2G network, a 3G network, an LTE network, and a WiMax network, respectively. It is illustrated in FIG. 4 that the mobile communication device 2000 includes only four interface modules 201a to 201d, but the mobile communication device 2000 may include five or more interface modules.

Meanwhile, one interface module needs not particularly to correspond to one mobile network. A separate physical interface module may not be present with respect to a predetermined mobile network and various interfaces may be provided with respect to another mobile network. When the mobile network is the LTE network, multiple sub-interface modules may be provided, in which LTE operators are different from each other. For example, when the mobile communication device 2000 operates in Korea, the mobile communication device 2000 may include three sub-interface modules of KT, SKI, and LGU+ (which are LTE MNOs (Mobile Network Operators)) in the LTE interface module 201.

The first to fourth interface modules 201a to 201d may perform the roles and at least one of the first to fourth interface modules 201a to 201d may communicate with the mobility control device 1000 through the Internet. That is, at least one interface module may serve as a module that communicates with the mobility control device 1000.

That is, at least one interface module may transmit the positional information of the mobile communication device 2000 to the mobility control device 1000 or receive the communication quality information, the mode setting signal, the load balancing policy information, and the like from the mobility control device 1000. The mobility control device 1000 and the mobile communication device 2000 may communicate (transmit and receive the information and the signal) with each other by at least one interface module at a predetermined cycle or whenever the position of the mobile communication device 1000 is changed.

The interface quality measuring module 203 may acquire the quality factors for the multiple mobile networks from the respective interface modules 201a to 201d. The acquired quality factors may be transferred to the interface control module. As described above, the quality factors include at least one of the received signal strength (RSS) values, the round trip time (RTT) values, and the relative bandwidth (RB) values for the multiple mobile networks, and the movement direction (MD) value and the movement speed (MS) value of the mobile communication device 200.

According to any exemplary embodiment, the interface quality measuring module 203 may monitor physical operation statuses of the respective interface modules 201a to 201d and whether the failure occurs in the respective interface modules 201a to 201d and when the failure occurs, the interface quality measuring module 203 may notify the occurrence of the failure to the interface control module 207.

The positional information acquiring module 205 may acquire geometric positional information of the mobile communication device 2000. The positional information may be calculated by triangulation or received from a GPS satellite.

The interface control module 207 may calculate the load balancing ratio based on communication quality information received from the outside (e.g., mobility control device 1000) and the quality factors measured by the interface quality measuring module 203. The communication quality information used to calculate the load balancing ratio may include quality factor weights for the multiple respective mobile networks in the area corresponding to the positional information of the mobile communication device 2000.

That is, the interface control module 207 may calculate the load balancing ratio which is a ratio of data to be shared by the respective interface modules 201a to 201d as shown in [Equation 1] given below based on the communication quality information (quality factor weight) and the quality factor value (‘dynamic mode’).

$$Qi = ( RSS \times Wrss ) + ( \frac{1}{RTT} \times Wrtt ) + ( RB \times Wrb ) + ( MD \times Wmd ) + ( MS \times Wms ) \qquad [ Equation 1 ]$$

(Qᵢ represents a transmission quality value of an i-th interface module)

The interface control module 207 may calculate the load balancing ratio by converting the transmission quality value Qᵢ of each interface module derived by [Equation 1] into a ratio.

For example, in the case of FIG. 3, when the mobile communication device 2000 is positioned at area #2 and four mobile networks may provide the service at area #2 (that is, i=4), the RSS value, the RTT value, the RB value, the MD value, and the MS value measured by the interface quality measuring module 203 may be calculated with quality factor weights 301 (Wrss=0.7, Wrtt=0.5, Wrb=0.3, Wmd=0.1, and Wms=1.0) and quality factor weights 302, 303, and 304 corresponding to other mobile networks, and as a result, four transmission quality values Q₁ to Q₄ may be obtained. The load balancing ratio may be derived from ratios of four transmission quality values Q₁ to Q₄ obtained through the calculation.

Meanwhile, the interface control module 207 may calculate the load balancing ratio at a predetermined cycle. However, the present invention is not limited thereto. The interface control module 207 may calculate the load balancing ratio again when receiving new communication quality information (quality factor weight) from the mobility control device 1000 depending on the positional change of the mobile communication device 2000 or when a rapid change in the quality factor of the interface 201 is sensed.

(The interface driver 209 of) The interface control module 207 may distribute traffic to the multiple interface modules 201a to 201d according to the calculated load balancing ratio. The interface driver 209 may perform initialization of the modules for smooth operations of the interface modules 201a to 201d in addition to a traffic distribution function to the multiple interface modules 201a to 201d.

According to any exemplary embodiment, the interface control module 207 may distribute the traffic at a predetermined load balancing ratio when the static mode setting signal is acquired from the mobility control device 1000. When the dynamic mode setting signal is acquired, the interface control module 207 may distribute the traffic according to the load balancing ratio calculated based on the communication quality information depending on the positional information and the quality factor measured in the interface.

According to any other exemplary embodiment, the interface control module 207 may calculate the load balancing ratio based on only a specific interface module indicated by the corresponding balancing policy information when acquiring the load balancing policy information.

According to any another exemplary embodiment, the interface modules 201 of the mobile communication device 2000 may include a preliminary interface module excluded in calculating the load balancing ratio under a general operation. The preliminary interface module is used to calculate the load balancing ratio when the mobile communication device 2000 operates under a specific situation.

For example, when the failure is sensed in at least one interface module by the interface quality measuring module 203, the interface control module 207 may consider (that is, include) the preliminary interface module and exclude the interface module of which the failure is sensed in calculating the load balancing ratio.

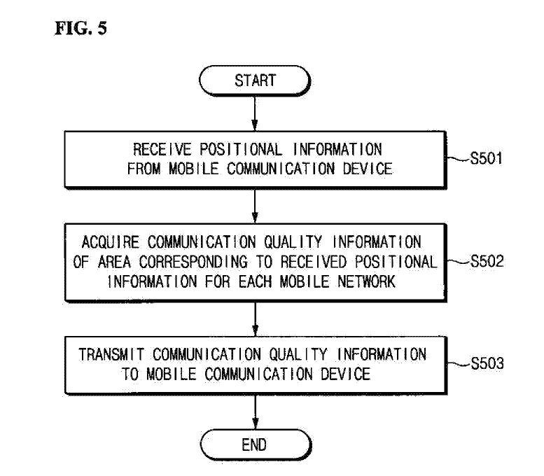

The configurations and operations of the mobile control device and the mobile communication device that provide the mobility service according to various exemplary embodiments of the present invention have been described above. Hereinafter, a method for providing a mobility service according to various exemplary embodiments of the present invention will be described with reference to FIGS. 5 to 9.

FIG. 5 illustrates a method in which a mobility control device 1000 provides a mobility service according to an exemplary embodiment of the present invention.

Referring to FIG. 5, in operation S501, a mobile communication device position managing module 103 of the mobility control device 1000 may receive positional information from a mobile communication device 2000. In this case, the positional information may be received at a predetermined cycle or dynamically received depending on a positional change of the mobile communication device 2000.

In operation S502, a control module 105 of the mobility control device 1000 may acquire communication quality information of an area corresponding to the positional information received in operation S501 for every multiple mobile networks by referring to a network quality managing module 101.

In this case, the communication quality information of the area corresponding to the positional information received in operation S501 may be acquired based on quality factors for the multiple mobile networks in the corresponding area. For example, the communication quality information in the corresponding area may be acquired as relative values (e.g., quality factor weights) of the quality factors for the multiple mobile networks in the area.

The quality factors may include at least one of RSS values, RTT values, and relative bandwidth (RB) values for the multiple mobile networks in the area, and a moving direction (MD) and a moving speed (MS) of the mobile communication device.

In operation S503, a communication module 107 of the mobility control device 1000 may transmit the communication quality information to the mobile communication device 2000. In this case, the communication quality information may be transmitted at a predetermined cycle or whenever the changed positional information of the mobile communication device 2000 is received.

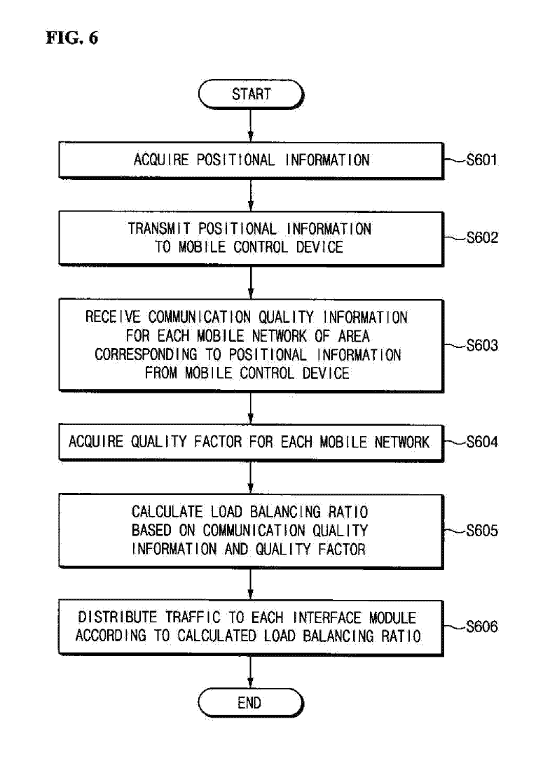

FIG. 6 illustrates a method in which a mobility communication device 2000 receives a mobility service according to an exemplary embodiment of the present invention.

Referring to FIG. 6, in operation S601, the mobile communication device 2000 may acquire the positional information of the mobile communication device 2000 by using a positional information acquiring module 205, for example, at a predetermined cycle or when a positional change of the mobile communication device 2000 is sensed.

In operation S602, at least one of multiple interface modules 201 of the mobile communication device 2000 may transmit the positional information acquired in operation S601 to the mobility control device 1000, for example, at a predetermined cycle or whenever the changed positional information of the mobile communication device 2000 is acquired.

In operation S603, the mobile communication device 2000 may receive the communication quality information (e.g., quality factor weight) for each mobile network of the area corresponding to the positional information transmitted in operation S602 from the mobility control device 1000 through at least one of the multiple interface modules 201. The communication quality information may be received at a predetermined cycle or whenever the changed positional information of the mobile communication device 2000 is transmitted.

In operation S604, an interface quality measuring module 203 of the mobile communication device 2000 may acquire a quality factor for each mobile network from the multiple interface modules 201. The quality factor may be acquired at a predetermined cycle or whenever the positional change of the mobile communication device 2000 is sensed.

The quality factor may include at least one of the RSS values, the RTT values, and the relative bandwidth (RB) values for the multiple mobile networks in the area, and the moving direction (MD) and the moving speed (MS) of the mobile communication device.

In operation S605, the interface control module 207 of the mobile communication device 2000 may calculate a load balancing ratio based on the communication quality information (e.g., quality factor weight) received in operation S603 and the quality factor acquired in operation S604. In detail, the load balancing ratio may be calculated by converting a transmission quality value Qi of each interface module 201 derived by [Equation 1] into a ratio. Meanwhile, the interface control module 207 may calculate the load balancing ratio at a predetermined cycle or whenever the communication quality information is received from the mobility control device 1000.

In operation S606, an interface driver 209 included in the interface control module 207 may distribute traffic to each interface module 201 according to the load balancing ratio calculated in operation S605.

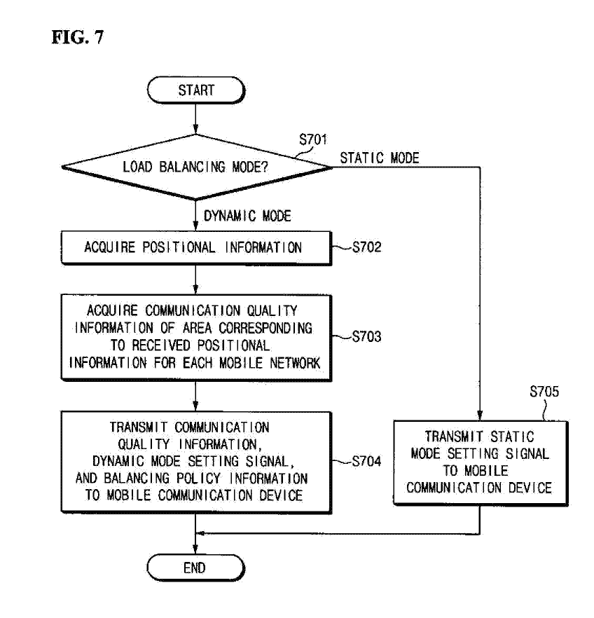

FIG. 7 illustrates a method in which a mobility control device 1000 provides a mobility service according to another exemplary embodiment of the present invention.

Since operations S702 to S704 of FIG. 7 may correspond to operations S501 to S503 of FIG. 5, respectively, a description of common parts will be omitted.

In operation S701, the control module 105 of the mobility control device 1000 may determine whether a load balancing mode set by a user is a dynamic mode or a static mode. When the load balancing mode is the dynamic mode, the process may proceed to operation S702 and when the load balancing mode is the static mode, the process may proceed to operation S705.

In operation S702, the mobile communication device position managing module 103 of the mobility control device 1000 may receive positional information from the mobile communication device 2000.

In operation S703, the control module 105 of the mobility control device 1000 may acquire communication quality information of an area corresponding to the positional information received in operation S702 for every mobile network by referring to the network quality managing module 101.

In operation S704, the communication module 107 of the mobility control device 1000 may transmit the communication quality information, a dynamic mode setting signal, and load balancing policy information to the mobile communication device 2000. The dynamic mode setting signal may be a signal that sets the mobile communication device 2000 to distribute traffic according to the load balancing ratio calculated based on the communication quality information depending on the positional information and the quality factor measured in the interface. The load balancing policy information may be information that indicates a specific interface module which the mobile communication device 2000 uses in distributing the traffic.

In operation S705, the communication module 107 of the mobility control device 1000 may transmit the static mode setting signal to the mobile communication device 2000. The static mode setting signal may be a signal that sets the mobile communication device 2000 to distribute the traffic at a predetermined load balancing ratio.

According to any exemplary embodiment, operation S702 may be performed before operation S701. That is, the load balancing mode may be determined based on the positional information received from the mobile communication device 2000.

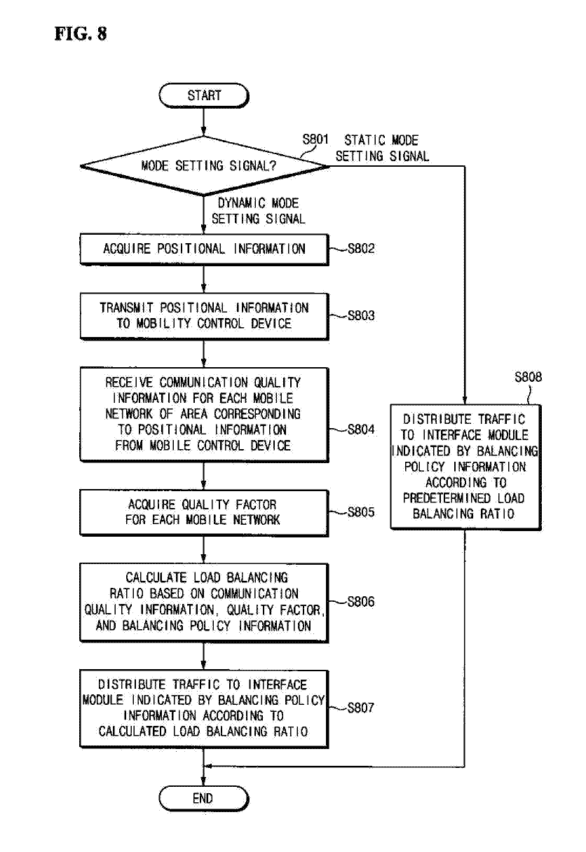

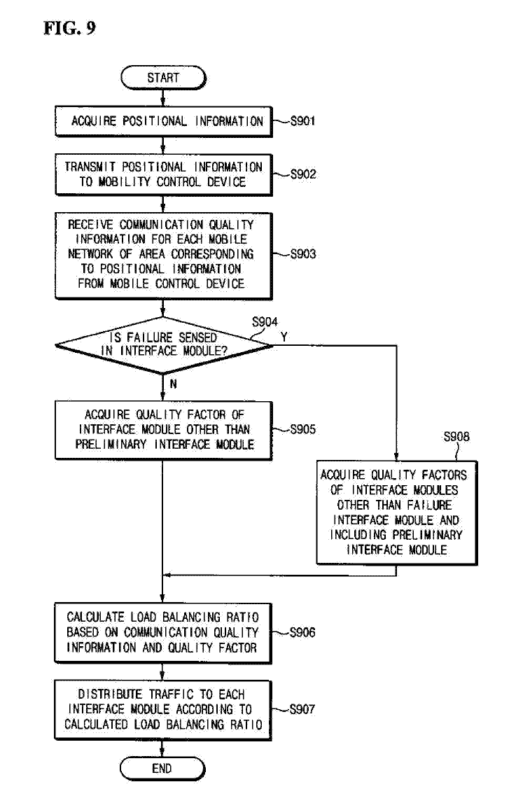

FIG. 8 illustrates a method in which a mobility communication device 2000 receives a mobility service according to another exemplary embodiment of the present invention.

Since operations S802 to S807 of FIG. 8 may correspond to operations S601 to S606 of FIG. 6, respectively, a description of common parts will be omitted.

In operation S801, the interface control module 207 of the mobile communication device 2000 may determine whether the mode setting signal received from the mobility control device 1000 is a dynamic mode setting signal or a static mode setting signal. When the mode setting signal is the dynamic mode setting signal, the process may proceed to operation S802 and when the mode setting signal is the static mode setting signal, the process may proceed to operation S808.

In operation S802, the mobile communication device 2000 may acquire the positional information of the mobile communication device 2000 by using the positional information acquiring module 205.

In operation S803, the positional information acquired in operation S802 may be transmitted to the mobility control device 1000 through at least one of the multiple interface modules 201 of the mobile communication device 2000.

In operation S804, the communication quality information and the load balancing policy information for each mobile network of the area corresponding to the positional information may be received from the mobility control device 1000 through at least one of the multiple interface modules 201 of the mobile communication device 2000. The load balancing policy information may be the information that indicates the interface module which the mobile communication device 2000 uses in distributing the traffic.

In operation S805, the interface quality measuring module 203 of the mobile communication device 2000 may acquire the quality factor for each mobile network from the multiple interface modules 201.

In operation S806, the interface control module 207 of the mobile communication device 2000 may calculate the load balancing ratio based on the communication quality information (e.g., quality factor weight), the quality factor, and the load balancing policy information.

In operation S807, the interface driver 209 included in the interface control module 207 may distribute the traffic to each interface module 201 according to the load balancing ratio calculated in operation S806.

In operation S807, since the mode setting signal received from the mobility control device 1000 is the static mode setting signal, the interface control module 207 of the mobile communication device 2000 may distribute the traffic to the interface module 201 indicated by the load balancing policy information at a predetermined load balancing ratio.

FIG. 9 illustrates a method for receiving the mobility service when failure occurs in the mobility communication device 2000 according to another exemplary embodiment of the present invention.

Since operations S901 to S903 and S905 to S907 of FIG. 9 may correspond to operations S601 to S606 of FIG. 6, respectively, a description of common parts will be omitted.

In operation S901, the mobile communication device 2000 may acquire the positional information of the mobile communication device 2000 by using the positional information acquiring module 205.

In operation S902, the positional information acquired in operation S802 may be transmitted to the mobility control device 1000 through at least one of the multiple interface modules 201 of the mobile communication device 2000.

In operation S903, the communication quality information for each mobile network of the area corresponding to the positional information may be received from the mobility control device 1000 through at least one of the multiple interface modules 201 of the mobile communication device 2000.

In operation S904, the interface control module 207 of the mobile communication device 2000 may determine whether the failure is sensed in at least one of the multiple interface modules by the interface quality measuring module 203. When the failure is not sensed, the process may proceed to operation S905 and when the failure is sensed, the process may proceed to operation S908.

In operation S905, the interface quality measuring module 203 of the mobile communication device 2000 may acquire the quality factor for the mobile network from modules other than a preliminary interface module among the multiple interface modules.

In operation S908, the interface quality measuring module 203 of the mobile communication device 2000 may acquire the quality factor for the mobile network from modules other than the interface module of which the failure is sensed and including the preliminary interface module among the multiple interface modules.

In operation S906, the interface control module 207 of the mobile communication device 2000 may calculate the load balancing ratio based on the communication quality information (e.g., quality factor weight) and the quality factor. In this case, the interface module excluded in acquiring the quality factor is not considered in calculating the load balancing ratio. Therefore, when operation S906 is performed subsequently to operation S905, the preliminary interface module may be excluded in calculating the load balancing ratio. On the contrary, when operation S906 is performed subsequently to operation S908, the interface module of which the failure is sensed may be excluded in calculating the load balancing ratio and the preliminary interface module may be considered in calculating the load balancing ratio.

In operation S907, the interface driver 209 included in the interface control module 207 may distribute the traffic to the interface module according to the load balancing ratio calculated in operation S906.

According to various exemplary embodiments of the present invention, since the traffic is distributed based on the communication quality information of the mobile network which is operating and the quality factors measured by the mobile communication device, interface operating efficiency and data traffic transmission efficiency may be increased by reflecting an actual network situation. In particular, when the present invention is applied to the mobile communication device in which a lot of users share an active tunnel like mobile routers installed in vehicles, trains, ships, and airplanes, a load balancing effect may be maximized, thereby improving stability of a service and user satisfaction.

According to any exemplary embodiment, since the traffic is distributed by considering the load balancing mode and the load balancing policy, the network may be flexibly operated by the user.

According to any exemplary embodiment, since the preliminary interface module is provided, although the failure occurs in any interface or mobile network, an immediate action against the failure may be taken, and as a result, stability of a network system may be improved.

Meanwhile, the aforementioned method of the present invention can be prepared even by a computer program. In addition, codes and code segments constituting the program can be easily deduced by a computer programmer skilled in the art. Further, the prepared program is stored in a computer readable recording medium (information storage medium) and is read and executed by a computer to implement the method of the present invention. In addition, the recording medium includes all types of computer readable recording media.

Specific executions described in the present invention as exemplary embodiments do not limit the scope of the present invention by any method. For simplification of the specification, circuit components, control systems, software, and other functional aspects of the systems in the related art may not be described. Further, connections of lines or connection members among components illustrated in the drawings exemplarily show functional connections and/or physical or circuit connections and may be expressed as replaceable or additional various function connections, physical connection, or circuit connections in actual devices. In addition, if not mentioned in detail like “requisitely”, “importantly”, and the like, the corresponding component may not be a component particularly required for applying the present invention.

In the specification (in particular, claims) of the present invention, a term of “the” and indication terms similar thereto may be used in both the singular number and the plural number. Further, when “range” is disclosed in the present invention, the range includes the present invention in which individual values included in the range is applied(if there is no disclosure contrary thereto) and it is the same as the respective individual values constituting the range being disclosed in the detailed description of the present invention. All examples or exemplary terms (e.g., etc) in the present invention are just used for, in detail, describing the present invention and if the examples or exemplary terms are not limited by the claims, the range of the present invention is not limited by the examples or exemplary terms. Further, it can be appreciated by those skilled in the art that various modifications, combinations, and changes may be configured according to a design condition and a design factor within the appended claims or a category equivalent thereto.

The present invention described as above is not limited by the aforementioned exemplary embodiments and the accompanying drawings because it will be apparent to those skilled in the art that various substitutions, modifications, and changes can be made within the scope without departing from the technical spirit of the present invention.

What is claimed is:

1. A mobility control device providing a mobility service in an environment with multiple mobile networks, the device comprising:
a network quality managing module monitoring and storing communication quality information for each of the multiple mobile networks depending on an area;
a control module acquiring communication quality information for each of the multiple mobile networks in an area corresponding to positional information received from a mobile communication device; and
a communication module transmitting the communication quality information to the mobile communication device.

2. The device of claim 1, wherein the communication quality information is acquired based on quality factors for the multiple mobile networks in the corresponding area.

3. The device of claim 1, wherein the communication quality information is acquired as relative values of the quality factors for the multiple mobile networks in the corresponding area.

4. The device of claim 1, wherein the positional information received from the mobile communication device is received at a predetermined cycle or whenever the position of the mobile communication device is changed.

5. The device of claim 2, wherein the quality factors include at least one of received signal strength (RSS) values, round trip time (Rn) values, and relative bandwidth (RB) values for the multiple mobile networks, and a moving direction (MD) and a moving speed (MS) of the mobile communication device in the area.

6. The device of claim 1, wherein the control module generates a static mode setting signal which is a signal that sets the mobile communication device to distribute traffic at a predetermined load balancing ratio, and
the communication module transmits the static mode setting signal to the mobile communication device.

7. The device of claim 1, wherein the control module generates load balancing policy information indicating an interface module which the mobile communication device uses in distributing the traffic, and
the communication module transmits the load balancing policy information to the mobile communication device.

8. A mobile communication device in an environment with multiple mobile networks, the device comprising:
multiple interface modules accessing the multiple mobile networks;
an interface quality measuring module acquiring quality factors for the multiple mobile networks from the multiple interface modules; and
an interface control module calculating a load balancing ratio based on communication quality information for the multiple respective mobile networks, which is received from a mobility control device and the quality factors and distributing traffic to the multiple interface modules according to the load balancing ratio.

9. The device of claim 8, further comprising:
a positional information acquiring module acquiring positional information of the mobile communication device,
wherein at least one of the multiple interface modules transmits the positional information to the mobility control device.

10. The device of claim 9, wherein the communication quality information includes communication quality information for the multiple respective mobile networks in an area corresponding to the positional information of the mobile communication device.

11. The device of claim 9, wherein the communication quality information is acquired based on the quality factors for the multiple respective mobile networks in the area corresponding to the positional information of the mobile communication device.

12. The device of claim 8, wherein the quality factors include at least one of received signal strength (RSS) values, round trip time (RTT) values, and relative bandwidth (RB) values for the multiple mobile networks, and a moving direction (MD) value and a moving speed (MS) value of the mobile communication device.

13. The device of claim 8, wherein the interface control module distributes the traffic at a predetermined load balancing ratio when acquiring a static mode setting signal.

14. The device of claim 8, wherein the interface control module calculates the load balancing ratio based on an interface module indicated by load balancing policy information when acquiring the load balancing policy information.

15. The device of claim 8, wherein when a preliminary interface module is included in the multiple interface modules, the interface control module excludes the preliminary interface module in calculating the load balancing ratio.

16. The device of claim 8, wherein when failure is sensed in at least one of the multiple interface modules, the interface control module excludes at least one interface module of which the failure is sensed in calculating the load balancing ratio.

17. The device of claim 16, wherein when the preliminary interface module is included in the multiple interface modules, the interface control module considers the preliminary interface module in calculating the load balancing ratio.

18. The device of claim 9, wherein the interface control module calculates the load balancing ratio at a predetermined cycle or whenever the communication quality information is received.

19. A method for providing a mobility service in an environment with multiple mobile networks, the method comprising:
receiving, by a mobility control device, positional information from a mobile communication device;
acquiring, by the mobility control device, communication quality information for each of the multiple mobile networks in an area corresponding to the positional information; and
transmitting, by the mobility control device, the communication quality information to the mobile communication device.

20. The method of claim 19, further comprising:
acquiring, by the mobile communication device, quality factors for the multiple mobile networks;
calculating, by the mobile communication device, a load balancing ratio based on the communication quality information and the quality factors; and
distributing, by the mobile communication device, traffic to the multiple mobile networks in accordance with the load balancing ratio.
